(19) United States
(12) Patent Application Publication
(10) Pub. No.: US 2021/0355723 A1
(43) Pub. Date: Nov. 18, 2021

(54) Latching System for Door or Window Panel

(71) Applicant: Mammoth Industries Pty Ltd, Thomastown (AU)

(72) Inventors: Craig Lang, Thomastown (AU); Matthew Keen, Thomastown (AU)

(21) Appl. No.: 17/320,679

(22) Filed: May 14, 2021

(30) Foreign Application Priority Data
May 15, 2020 (AU) 2020901570

(51) Int. Cl. E05C 1/12; E05B 65/00; E05D 15/26

(52) U.S. Cl. CPC E05C 1/12; E05B 65/0085; E05Y 2900/148; E05Y 2900/132; E05D 15/264

(57) ABSTRACT

Door and window panels for use in building construction, and particularly bi-folding door and window panels. A latch mechanism and associated bolt are provided with a track to guide the bolt and a hinge fixing portion being disposed within the track. The hinge fixing portion provides a point of attachment for the hinge, and is movable within the track so as to be locatable at any level along the door or window panel as desired. The hinge fixing portion and/or track may be configured such that the hinge fixing portion is maintained clear of the bolt to allow the bolt to slide thereunder. In that context, the hinge fixing portion may perform two tasks: firstly the task of providing an anchor for the hinge, and secondly for maintaining itself clear of a bolt within the track.

### FIELD OF THE INVENTION

The present invention relates generally to door and window panels for use in building construction, and particularly bi-folding door and window panels. More particularly, but not exclusively, the invention relates to latching systems for door and window panels including an extruded portion, with a latch mechanism, bolt, and hinges being accommodated by the extruded portion.

### BACKGROUND TO THE INVENTION

It is known in the art to use plastics such as UPVC or fibreglass in the fabrication of a door panel, or at least to form the stile of a door panel. The use of plastics lowers the cost of production, thermal conductivity and also the weight of the panel, and such materials are therefore generally preferred materials for many applications. Light weight metals such as aluminium may be used as an alternative to plastics, however generally the cost is greater.

To simplify the production of door panels, elongate extrusions of plastic or metal may be used to fabricate a portion of the panel, such as a stile or the rail. Often, multiple extrusions are formed into a frame, with glazing or an opaque panel being located in a groove or lip formed about the centrally facing edges of the frame.

An extrusion will have a cross-sectional profile appropriate for the respective type of door or window. A stile extrusion may be formed so as to provide channels and recesses to accommodate varying mechanisms such as friction stays, tilt-and-turn mechanisms, sliding latches and the like. These channels often have standardised dimensions irrespective of the manufacturer to provide at least some modularity with regard to combining the door or window panel with various items of hardware. One example of such standardisation is referred to in the art as a “Eurogroove Channel”.

A problem in the art is that a given extrusion will not necessarily be able to accommodate a particular type of hinge. For example, asymmetrical hinges are often used on bi-fold doors and windows to allow the panels to hinge greater than 90 degrees. Variations in the hinges (such as degrees of asymmetry, location of mounting holes etc) and variations in the location of hinges on the panel mean that there is a restricted ability to mix and match extrusions and hinges.

Similar problems arise with latch mechanisms which are produced in a wide variety of shapes and sizes such that a given mechanism may not be compatible with a certain extrusion. As will be appreciated, a latch mechanism may further require at least one track to guide a movable bolt into the door frame. In some cases, two guiding tracks are required (one extending upwardly and another downwardly) to allow for the greater security of two bolts. Again, a given extrusion profile will not accept all bolt arrangements. In many cases, a latch mechanism will include a locking mechanism for security thereby potentially compounding compatibility issues.

A further problem in the art arises for latching systems having a movable bolt which extends upwardly or downwardly through the stile and into the surround frame so as to lock and unlock the panel. Typically, the movable bolt must pass through or about a corner fixing mechanism (such as a corner stake, a key or a connector) which secures the stile to a horizontal panel member (such as the top or bottom rail). In such arrangements, the corner fixing mechanism may need to be specially designed to accommodate the movable bolt. In some circumstances, the corner fixing mechanism is at least compromised in its function by the need to accommodate the movable bolt.

Yet a further problem in the art is that once installed, some items of hardware are not easily removable for servicing or replacement. In particular, latch mechanisms (with any associated bolt) are often configured for permanent installation in a panel, and are virtually impossible to remove. Even where removal is possible, significant disassembly and reassembly is required. Many prior art systems allow for servicing of the latching mechanism, hinge mounting and movable bolt from a front face of the panel, however such systems typically require exposure of fixing hardware on the front face.

Many prior art systems require customized tooling or machining in the manufacturing process, thereby adding to production costs. In some instances, production costs are increased by the need to fit any part of a latching system to any part other than an open face of the panel.

It is an aspect of the present invention to provide an improvement to systems for retaining hardware on door and window panels. It is a further aspect of the present invention to provide a useful alternative to such prior art systems.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

### SUMMARY OF THE INVENTION

In a first aspect, but not necessarily the broadest aspect, the present invention provides a system for latching a door or window to a frame, the system comprising:
a latch mechanism having a body and a movable bolt;
an elongate extrusion having a recess configured to retain the latch mechanism body, the recess and/or latch mechanism body being adapted to allow the latch mechanism body to be inserted into and optionally removed from the elongate extrusion via a lateral side of the elongate extrusion;
a latch mechanism body fixing portion that is integral with, or retainable by, the elongate extrusion and the latch mechanism body being fixed to the latch mechanism body fixing portion,
an elongate bolt track that is integral with, or retainable by, the elongate extrusion and configured to guide the movable bolt;
a hinge fixing portion retained in a position relative to the movable bolt so as to allow movement thereof; and
a hinge fixed to the hinge fixing portion.

In one embodiment of the first aspect, the elongate extrusion is, or forms part of, a stile of a door or window panel.

In one embodiment of the first aspect, the latch mechanism body fixing portion is slidably engaged with a channel of the elongate extrusion.

In one embodiment of the first aspect, the system comprises two latch mechanism body fixing portions, wherein one of the two latch mechanism body fixing portions is configured to slide toward a first end region of the latch mechanism body, and the other of the two latch mechanism body fixing portions is configured to slide toward a second end region of the latch mechanism body.

In one embodiment of the first aspect, the latch mechanism body is configured to be fastened to the latch mechanism fixing portion(s) and the latch mechanism body fixing portion(s) is/are configured to receive a fastener including a screw so as to fix the latch mechanism body to the latch mechanism body fixing portion.

In one embodiment of the first aspect, the elongate bolt track is retainable by the elongate extrusion, the elongate bolt track is fixed to the latch mechanism body fixing portion.

In one embodiment of the first aspect, the elongate bolt track is fixed to the latch mechanism body fixing portion by a fastener including a screw.

In one embodiment of the first aspect, the movable bolt and/or latch mechanism is/are configured to allow the movable bolt to be attached to and optionally detached from the latch mechanism.

In one embodiment of the first aspect, the elongate bolt track comprises a laterally extending flange configured to function as the hinge fixing portion.

In one embodiment of the first aspect, the hinge fixing portion is a member disposed clear of the movable bolt and disposed within the elongate bolt track.

In one embodiment of the first aspect, the hinge fixing portion is a discrete component configured to be disposed within the elongate bolt track and removable therefrom.

In one embodiment of the first aspect, the system comprises two hinge fixing portions, the first hinge fixing portion being a member disposed clear of the movable bolt and disposed within the elongate bolt track, and the second hinge fixing portion being a flange extending laterally from the elongate bolt track.

In one embodiment of the first aspect, the hinge fixing portion(s) is/are configured to receive a receive fastener including a screw so as to fix the hinge to the hinge fixing portion(s).

In one embodiment of the first aspect, the hinge fixing portion(s) comprise a threaded screw hole and hinges comprise a screw hole and the hinge is located over the hinge fixing portion(s) and fixed thereto by a screw.

In one embodiment of the first aspect, the screw maintains the hinge fixing portion in a fixed position.

In one embodiment of the first aspect, the hinge fixing portion disposed within the bolt track is maintained clear of the bolt by a shoulder of the hinge fixing portion siting on a hip of the bolt track.

In one embodiment of the first aspect, the system comprising a weather seal configured to a portion configured to contact surface(s) of the elongate bolt track and/or the cleat.

In a second aspect, the present invention provides a bi-fold door or window comprising two panels in hinged connection, wherein one or both of the two panels comprises the system of any embodiment of the first aspect.

### BRIEF DESCRIPTION OF THE FIGURES

FIG. 1 illustrates an exploded view of a preferred embodiment of the present system.

FIG. 2 illustrates an assembled portion of the preferred system shown in FIG. 1

FIG. 3 illustrates a cross-section of the assembled portion shown in FIG. 2.

FIG. 4 is a magnified portion of the cross-section shown in FIG. 3.

FIG. 5 illustrates the disassembly and removal of the latch mechanism body.

FIG. 6 illustrates an embodiment of the invention having a removable weather seal.

Unless otherwise indicated herein, features of the drawings labelled with the same numeral are taken to be the same features, or at least functionally similar features, when used across different drawings.

The drawings are not prepared to any particular scale or dimension and are not presented as being a completely accurate presentation of the various embodiments.

### DETAILED DESCRIPTION OF THE INVENTION AND PREFERRED EMBODIMENTS THEREOF

After considering this description it will be apparent to one skilled in the art how the invention is implemented in various alternative embodiments and alternative applications. However, although various embodiments of the present invention will be described herein, it is understood that these embodiments are presented by way of example only, and not limitation. As such, this description of various alternative embodiments should not be construed to limit the scope or breadth of the present invention. Furthermore, statements of advantages or other aspects apply to specific exemplary embodiments, and not necessarily to all embodiments, or indeed any embodiment covered by the claims.

Throughout the description and the claims of this specification the word “comprise” and variations of the word, such as “comprising” and “comprises” is not intended to exclude other additives, components, integers or steps.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may.

As used herein, positional terms such as “lateral”, “across”, “above”, “below”, “higher”, “lower”, “upward”, “downward”, and the like are to be considered with reference to either the orientation a drawing to which the positional term relates, or with reference to the orientation of the system when installed an operable, as required by the appropriate context.

The term “latch mechanism” is intended to include any mechanism configured to prevent the hinged or sliding movement of a panel relative to a fixed surround of the panel when activated. When deactivated, the latch mechanism allows such relative movement. In some circumstances a latch mechanism is operably connected to a locking mechanism configured to prevent deactivation of the latch mechanism unless the locking mechanism is itself firstly deactivated by a key, a code, a voice command or similar.

The present invention is predicated at least in part on the inventors' discovery that advantage is provided at least some embodiments where a latch mechanism and associated bolt are provided with a track to guide the bolt and a hinge fixing portion being disposed within the track. The hinge fixing portion provides a point of attachment for the hinge, and is movable within the track so as to be locatable at any level along the door or window panel as desired. The hinge fixing portion and/or track may be configured such that the hinge fixing portion is maintained clear of the bolt to allow the bolt to slide thereunder. In that context, the hinge fixing portion may perform two tasks: firstly the task of providing an anchor for the hinge, and secondly as a means for maintaining itself clear of a bolt within the track.

The hinge will typically be attached not only to the hinge fixing portion, but also a second portion of the system which is fixed (i.e. is unable to move) relative to the panel. In one embodiment, that second portion is a flange that extends laterally and from an upper edge from the track. In that regard, the track also performs two functions: its normal function of guiding the bolt and a second function of providing a means for fixing a hinge to the panel. This fixing is an indirect fixing to the panel in so far as the hinge is fixed to the track, and the track is fixed to the panel.

Advantageously for some embodiments, a hinge fixing portion may be moved along the track to allow for customized positioning of the hinges. A hinge may be moved to a particular position with reference to the panel or panel-associated hardware. Furthermore, multiple hinge fixing portions may be introduced according to need, with each hinge fixing portion being movable relatively to each other so as to provide a customized spacing between hinges.

With regard to the latch mechanism, advantage is provided in some embodiments in that the system comprises a latch mechanism fixing portion which, in some embodiments, is/are separate to the extrusion and can be moved independently thereof. Thus, the latch mechanism fixing portion may be adjusted spatially relative to the latch mechanism. This allows for the use of wide variety of latch mechanisms with a given extrusion. The extrusion may have a recess dimensioned so as to receive a large latch mechanism, although such a recess could also accommodate a smaller latch mechanism. The larger or smaller latch may be retaining in the recess by moving the latch mechanism fixing portion so as to be positioned, for example, under a screw hole of the latch mechanism concerned. Once the latch mechanism fixing portion is properly located, a fastener can be used to secure the mechanism to the fixing portion. To prevent movement of the latch mechanism after it is secured, the latch mechanism fixing portion may be fixed directly or indirectly to the extrusion or otherwise prevented from moving relative to the extrusion. In some embodiments, the latch mechanism fixing portion may be fixed directly or indirectly to the track, and the track is directly or indirectly fixed to the extrusion so as to prevent relative movement.

As will be apparent from above, various components of the system may have multiple functions and form mechanical connections with more than one other component.

Yet a further advantage for some embodiments is that a latch mechanism is easily removable laterally from a door or window panel for servicing or repair.

The present invention will now be more fully described by reference to the preferred embodiments of the drawings, and also variations to the preferred embodiments. It will be understood that any variations as described in reference to the preferred embodiments of the drawings are applicable to broader forms of the invention and should not be taken as limited to application in respect of the embodiments drawn.

Those skilled in the art will appreciate that the invention described herein is susceptible to further variations and modifications other than those specifically described. It is understood that the invention comprises all such variations and modifications which fall within the spirit and scope of the present invention.

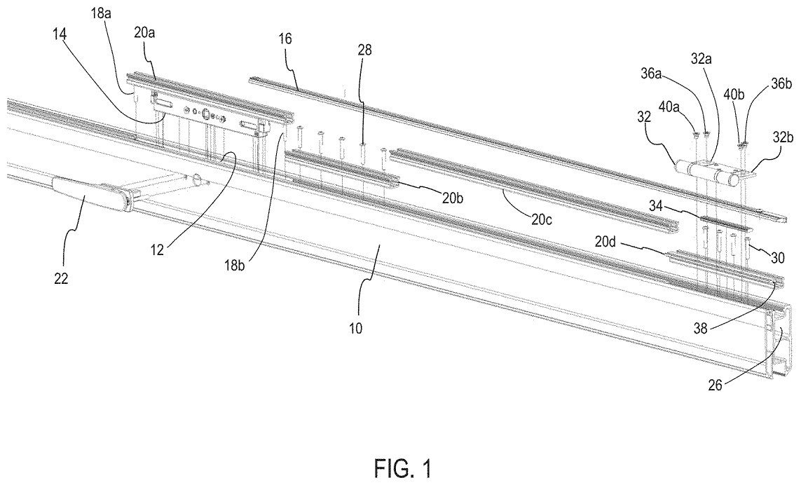

Turning firstly to FIG. 1, there is shown an extrusion (10) having a recess (12) dimensioned to receive the body (14) of a latch mechanism. The latch mechanism is a “twin-bolt” arrangement and includes two detachable/attachable bolts. One of the bolts (16) of the latch mechanism is shown in the drawing in the detached state.

In this embodiment, the latch mechanism body (14) is fixed using two screws (18a, 18b) which secure into an underlying latch mechanism body fixing portion (not shown in this drawing). The latch mechanism body (14) is associated with a first bolt track portion (20a) which acts to guide the two bolts (when attached). Further bolt track portions (20b, 20c, 20d) are provided, with all bolt track portions (20a, 20b, 20c, 20d) together forming a functionally single track along which the bolt (16) is guided when the latching mechanism is operated by a user via the handle (22).

The screws (18a, 18b) function to attach not only the latch mechanism body (14), but also the bolt track portion (20a) with which it is associated. The second bolt track portion (20b) is fixed by a series of screws (one marked 28) which secure into the underlying latch mechanism body fixing portion. Although not apparent from this drawing, the latch mechanism body fixing portion extends all the way to the end of extrusion at right (as drawn) and a second latch mechanism body fixing portion extends from the left (as drawn) side of the latch body to the end of the extrusion at left (not shown in this drawing). At this point of the description, it may be noted that the latch mechanism body fixing portion runs through the space (26) of the extrusion (10).

The third bolt track portion (20c) is not secured with screws to any proximal structure, and is instead held in place by a friction fit therewith.

The fourth bolt track portion (20d) extends the bolt track so far as the end of the extrusion (10), and is secured to the underlying latch mechanism body fixing means with a series of screws (one of which is marked 30).

The fourth bolt track portion (20d) is a portion having an associated hinge (32). The leaves (32a, 32b) of hinge (32) are fastened to the cleat (34) by way of two screws (36a, 36b). The cleat (34) is prevented from falling down into the fourth bolt track portion (20d) by sitting on a hip of track portion (20d). Nevertheless, the cleat (34) is able to slide along the track portion (20d) so as to co-locate with a hinge. the hip maintains the upper surface of the cleat (34) level with the upper edge of fourth bolt track portion (20d), and furthermore maintains it elevated over the floor of the track portion (20d) and also the heads of screws (30) so as to provide a clearance between the floor of the track portion (20d) and the lower face of the cleat (34). The clearance allows for the bolt (16) to move along the track portion (20d). As will be appreciated, the screws (36a, 36b) are necessary short so as to not extend into the clearance maintained under the cleat (34) to allow passage of the bolt (16).

The hinge leaves (32a, 32b) are fastened to a lateral flange (38) of the fourth track portion (20d) by way of screws (40a, 40b).

By this arrangement, the lower face of each of the hinge leaves (32a, 32b) rests on the upper surfaces of the fourth bolt track portion (20d), such surfaces including the lateral flange (38). It will be appreciated that if the hinge leaves (32a, 32b) where fastened only to the cleat (34) then the hinge would be undesirably movable given that the cleat (34) is not fixed to any other structure. The fastening of the hinge leaves (32a, 32b) also to the fourth bolt track portion (20d) via its flange (38), and fastening of the fourth bolt track portion (20d) to the extrusion (10) via the latch mechanism body fixing portion that extends into the space (26) prevents movement of the hinge (32) relative to the extrusion (10).

The hinge leaf between the leaves (32a) and (32b) remains unfixed and therefore free to pivot so as to be attachable to a second panel of a bi-fold door arrangement. In some embodiments, the second panel may comprise a system as described herein for the first panel, and in that regards the present invention extends in some embodiments to a bi-fold door or window arrangement with at least two panels and at least one (and optionally both) of the two panels comprising a system as described herein.

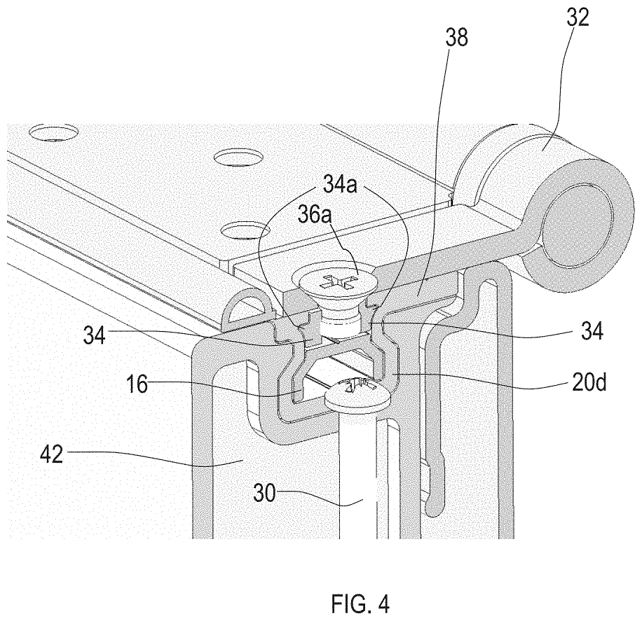

Reference is now made to FIG. 4 which shows in greater detail the retention of the cleat (34) within the fourth bolt track portion (20d). As will be seen the cleat (34) has a shoulder (34a) which rests on an underlying hip formed in the fourth bolt track portion (20d).

As will also be noted from FIG. 4, the bolt (16) is formed into an inverted U-shape to allow it pass over the underlying heads of the screws (30). The bolt (16) need be formed in this way only in sections of the bolt track (20) that overlie a screw head. Of course, such formation of the bolt (16) would not be necessary if the screws were countersunk, however such an arrangement results in increased production costs.

FIG. 3 and FIG. 4 show the latch mechanism body fixing portion inside the extrusion space (26), which is in this embodiment a length of wood (42). Materials other than wood will have utility, so long as they provide a means to anchor a fastener such as a screw. The material may be a bonded particle wood product or a completely synthetic polymer. The fixing portion need not be continuous, but typically will be to simply production, with a single length being inserted from an end of the extrusion and all the way to the latch mechanism body.

a preferred embodiment, the bolt (which forms part of the latch mechanism) is formed separately and is configured to be attachable to (and optionally detachable from) a bolt actuator of the latch mechanism body. By this arrangement the bolt can be inserted longitudinally into the bolt track and once the terminus of the bolt is sufficiently proximal to the bolt actuator, the bolt can be attached to the actuator. Once attached, actuation of the actuator (by a user) results in the bolt moving alternately between a retracted position and an extended position, the latter being required to secure the door or window panel to its frame.

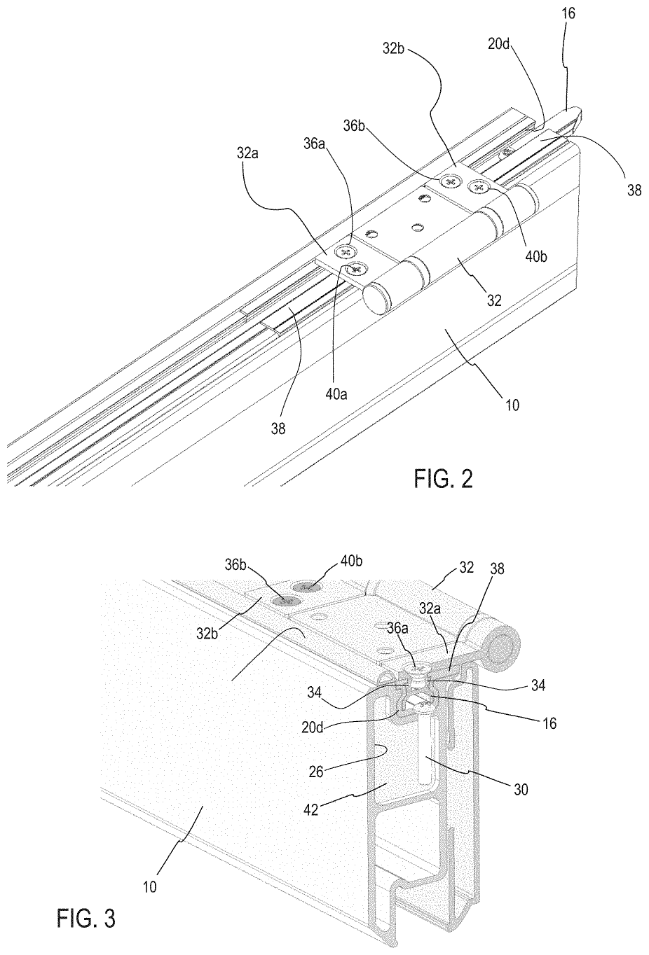

The use of an attachable/detachable bolt provides further advantage with regards to removal of the locking mechanism body for servicing or replacement. As will be clear from FIG. 2, when the extrusion is assembled with a hinge (32), the hinge (32) blocks removal of the bolt (16) laterally and away from the extrusion. Where the latch mechanism body (14) is permanently fixed to the bolt (16), the hinge (32) also prohibits removal of the body (14) from its recess (12). According to one embodiment of the present invention, the bolt (16) is detachable from its actuator within the latch mechanism body (14), and in a manner that is readily achievable such that the bolt (16) may remain in its track (20) and the latch mechanism body (14) is therefore freed for removal. Upon replacement, the latch mechanism body may be seated in its recess (12) and the bolt (16) reattached.

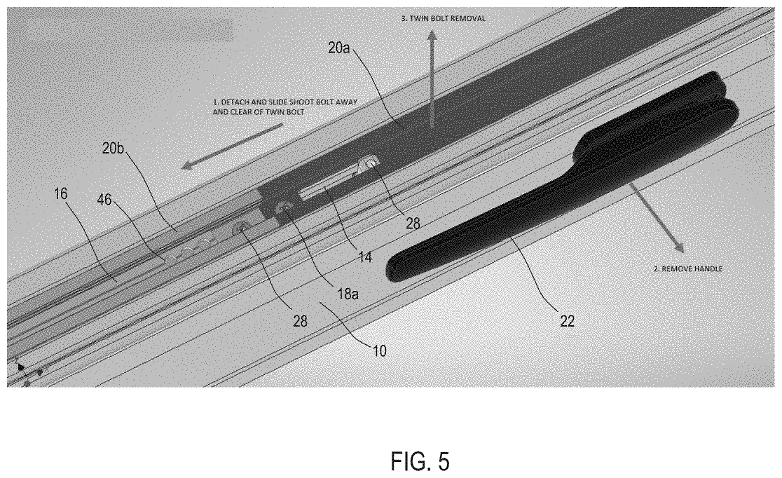

Reference is made to FIG. 5, which shows the bolt (16) detached. The bolt (16) terminal region has three aligned screw holes (one marked 46). When required, the bolt (16) is slid to the right (as drawn) such that one of the screw holes (46) overlies the bolt actuator screw hole (48) of the latch mechanism body (14). Once screw holes (46) and (28) are aligned, a screw is driven to fasten the bolt (16) to its actuator. The option of three screw holes (46) allows for adjustment of the bolt (16) relative to its actuator.

Detachment is the reversal of the preceding method. Once the bolt (16) is freed and slid away from the latch mechanism body (14) and is associated track (20a) the latch mechanism actuator (the handle (22)) is removed. The screws (18a) and (18b) are removed to allow for the upward removal of the latch mechanism body for servicing or replacement.

In terms of the order for assembling the system de novo, the latch mechanism body (14) with associated bolt track portion (20a) is lowered such that the body (14) sits within the recess (12) of the extrusion (10). Latch body mechanism fixing portion (42) is slid into the space (26) of the extrusion (10) so as to be engageable by screws (18a) and (18b). Once screws (18a) and (18b) are driven, the handle actuator (22) is engaged with the locking mechanism body (14). Further track portions are laid into the extrusion and fixed into place with screws. The bolt (16) is inserted into the tracks portions (20) and the terminus secured to the bolt actuator of the latch mechanism body (14). One or more cleats (34) and associated hinges (32) are then attached.

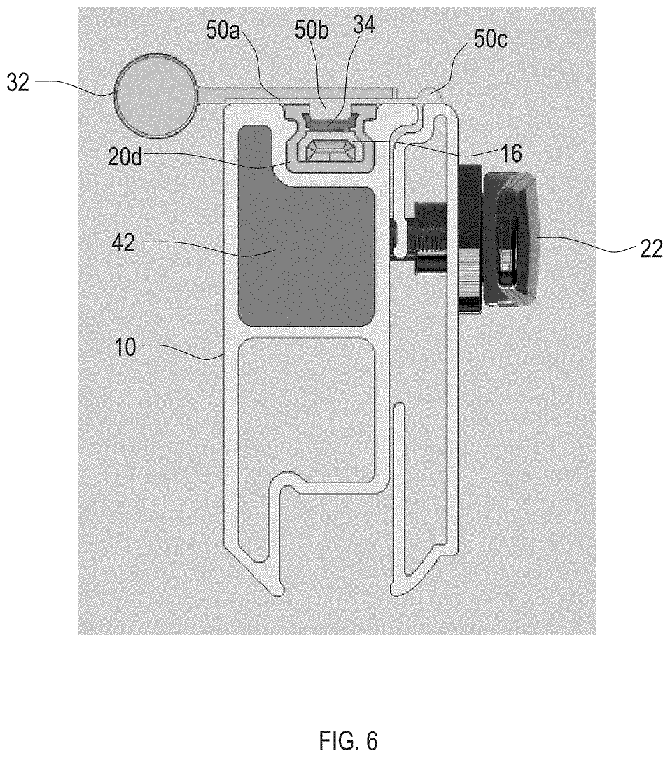

The embodiment of FIG. 6 comprises a weather seal (50) which is composed of a deformably resilient and water resistant material. The weather seal (50) comprises a planar portion (50a) which sits flush with the extrusion edge face, an expanded portion (50b) which seats in the space formed by the upper surfaces of the cleat (34) and the bolt track portion (20d) walls. A protrusion (50c) is confirmed to seal against the edge of another door panel thereby resistant entry of weather through the space that is inevitably formed between adjacent door panels.

In the embodiment of the drawings, and indeed other embodiments, it will noted that a panel may be fabricated such that the hardware (latch mechanism body, tracks etc) can be fitted to an open face of the extrusion. That features affords advantage in manufacture.

As a further advantage, as will be apparent from the embodiment of the drawings, and indeed other embodiments, the present system allows for servicing of the latching mechanism, and/or the hinge mountings and/or the bolt mechanism from the non-visible folded edges of the panels. This is possible while at the same time allowing for concealment of all fixings and profiles when the panel is in the highly visible closed position, as for a bi-fold door.

In the embodiment of the drawings, and indeed other embodiments, it will noted that the movable bolts are disposed parallel and very proximal to the externally facing edge of the stile. That arrangement leaves a considerable portion of the stile available to contain corner fixing means such as a corner stake, a connector or key thereby allowing for improvements in joining the stile holding the latching mechanism and bolt to a horizontal rail of a panel. For example, a key may extend from a rail horizontally and deep in the stile such that the parts more fully mutually engage, and without any need to avoid interference with the bolt and/or track.

In the embodiment of the drawings, the extrusion is shaped and dimensioned so as to provide a standard Eurogroove Channel, and the various hardware components of the present system such as the latch mechanism body, tracks and the like are shaped and dimensioned so as to fit into the Eurogroove Channel. The use of an industry standard channel lowers the need for new tooling and processes to manufacture a door or window panel incorporating the present system. Productions costs are also therefore lessened.

The present invention is of course applicable to other industry standard channel configurations, or any other existing channel or a newly designed customized channel.

While the invention has been disclosed in connection with the preferred embodiments shown and described in detail, various modifications and improvements thereon will become readily apparent to those skilled in the art.

Accordingly, the spirit and scope of the present invention is not to be limited by the foregoing examples, but is to be understood in the broadest sense allowable by law.

1. A system for latching a door or window to a frame, the system comprising:
a latch mechanism having a body and a movable bolt;
an elongate extrusion having a recess configured to retain the latch mechanism body, the recess and/or latch mechanism body being adapted to allow the latch mechanism body to be inserted into the elongate extrusion via a lateral side of the elongate extrusion;
a latch mechanism body fixing portion that is integral with, or retainable by, the elongate extrusion and the latch mechanism body being fixed to the latch mechanism body fixing portion;
an elongate bolt track that is integral with, or retainable by, the elongate extrusion and configured to guide the movable bolt;
a hinge fixing portion retained in a position relative to the movable bolt so as to allow movement thereof; and
a hinge fixed to the hinge fixing portion.

2. The system of claim 1, wherein the elongate extrusion is, or forms part of, a stile of a door or window panel.

3. The system of claim 1, wherein the latch mechanism body fixing portion is slidably engaged with a channel of the elongate extrusion.

4. The system of claim 3, comprising two latch mechanism body fixing portions, wherein one of the two latch mechanism body fixing portions is configured to slide toward a first end region of the latch mechanism body, and the other of the two latch mechanism body fixing portions is configured to slide toward a second end region of the latch mechanism body.

5. The system of claim 1, wherein the latch mechanism body is configured to be fastened to the latch mechanism fixing portion(s) and the latch mechanism body fixing portion(s) is/are configured to receive a fastener including a screw so as to fix the latch mechanism body to the latch mechanism body fixing portion.

6. The system of claim 1, wherein where the elongate bolt track is retainable by the elongate extrusion, the elongate bolt track is fixed to the latch mechanism body fixing portion.

7. The system of claim 6, wherein the elongate bolt track is fixed to the latch mechanism body fixing portion by a fastener including a screw.

8. The system of claim 1, wherein the movable bolt and/or latch mechanism is/are configured to allow the movable bolt to be attached to and optionally detached from the latch mechanism.

9. The system of claim 1, wherein the elongate bolt track comprises a laterally extending flange configured to function as the hinge fixing portion.

10. The system of claim 1, wherein the hinge fixing portion is a member disposed clear of the movable bolt and disposed within the elongate bolt track.

11. The system of claim 10, wherein the hinge fixing portion is a discrete component configured to be disposed within the elongate bolt track and removable therefrom.

12. The system of claim 1, comprising two hinge fixing portions, the first hinge fixing portion being a member disposed clear of the movable bolt and disposed within the elongate bolt track, and the second hinge fixing portion being a flange extending laterally from the elongate bolt track.

13. The system of claim 1, wherein the hinge fixing portion(s) is/are configured to receive a receive fastener including a screw so as to fix the hinge to the hinge fixing portion(s).

14. The system of claim 13, wherein the hinge fixing portion(s) comprise a threaded screw hole and hinges comprise a screw hole and the hinge is located over the hinge fixing portion(s) and fixed thereto by a screw.

15. The system of claim 1, wherein the hinge fixing portion disposed within the bolt track is maintained clear of the bolt by a shoulder of the hinge fixing portion siting on a hip of the bolt track.

16. The system of claim 15, wherein the screw maintains the hinge fixing portion clear of the movable bolt.

17. The system of claim 1, comprising a weather seal comprising a portion configured to contact surface(s) of the elongate bolt track and/or the cleat.

18. A bi-fold door or window comprising:
first and second panels in hinged connection, wherein one or both of the first and second panels comprises a system for latching a door or window to a frame, the system comprising:
a latch mechanism having a body and a movable bolt;
an elongate extrusion having a recess configured to retain the latch mechanism body, the recess and/or latch mechanism body being adapted to allow the latch mechanism body to be inserted into the elongate extrusion via a lateral side of the elongate extrusion;
a latch mechanism body fixing portion that is integral with, or retainable by, the elongate extrusion and the latch mechanism body being fixed to the latch mechanism body fixing portion;
an elongate bolt track that is integral with, or retainable by, the elongate extrusion and configured to guide the movable bolt;
a hinge fixing portion retained in a position relative to the movable bolt so as to allow movement thereof; and
a hinge fixed to the hinge fixing portion.
